(19) United States
(12) Patent Application Publication
(10) Pub. No.: US 2026/0308367 A1
(43) Pub. Date: Oct. 8, 2026

(54) METHOD FOR PRODUCING FOAM BLOW MOLDED BODY, AND FOAM BLOW MOLDED BODY

(71) Applicant: JSP Corporation, Tokyo (JP)

(72) Inventors: Masahiro GOMIBUCHI, Tochigi (JP); Jinichiro NORO, Tochigi (JP)

(73) Assignee: JSP Corporation, Tokyo (JP)

(21) Appl. No.: 18/996,792

(22) PCT Filed: Jul. 18, 2023
(86) PCT No.: PCT/JP2023/026245

§ 371 Date: Jan. 17, 2025

(30) Foreign Application Priority Data
Jul. 19, 2022 (JP) 2022-115020

(51) Int. Cl. C08L 23/12; C08J 9/00

(52) U.S. Cl. CPC C08L 23/12; C08J 9/0061; C08J 2201/03; C08J 2323/12; C08J 2453/00; C08L 2203/14; C08L 2205/025; C08L 2205/03; C08L 2207/04

(57) ABSTRACT

The present invention relates to a method for producing a foamed blow-molded article, including blow-molding a foamed parison obtained by foaming a mixed resin containing a polyolefin-based resin (A) and an olefin-based thermoplastic elastomer (B), in which the polyolefin-based resin (A) contains a branched homopolypropylene (a1) and a linear block polypropylene (a2), and a mass ratio (a1):(a2) is 50:50 to 93:7, the olefin-based thermoplastic elastomer (B) is a hydrogenated product of a triblock copolymer containing a crystalline olefin polymer block and a polymer block of a conjugated diene compound, and in the mixed resin, a blending amount of the olefin-based thermoplastic elastomer (B) with respect to 100 parts by mass of the polyolefin-based resin (A) is 20 parts by mass or more and 40 parts by mass or less.

### TECHNICAL FIELD

The present invention relates to a method for producing a foamed blow-molded article and a foamed blow-molded article.

### BACKGROUND ART

Foamed blow-molded articles are obtained by shaping a foamed parison formed from a foamable resin melt containing a base resin. Among the foamed blow-molded articles, a hollow molded article using a polyolefin-based resin as the base resin has been used in various applications such as air conditioning ducts in automobiles from a viewpoint of lightweight. Hereinafter, the air conditioning ducts may be referred to as ducts.

In recent years, the foamed blow-molded articles are required to have lightweight and cold-impact resistance. The cold-impact resistance refers to impact resistance of the foamed blow-molded article at a low temperature. To improve the cold-impact resistance of the foamed blow-molded article, Patent Literatures 1 and 2 disclose techniques for adding an elastomer to a polypropylene-based resin.

### CITATION LIST

### Patent Literature

Patent Literature 1: WO2020/059112
Patent Literature 2: JP2018-141031A

### SUMMARY OF INVENTION

### Technical Problem

The techniques disclosed in Patent Literatures 1 and 2 have a problem of a need of further improvements in the cold-impact resistance and rigidity of the foamed blow-molded article. The techniques disclosed in Patent Literatures 1 and 2 also have a problem of a need of an improvement in surface smoothness in an inner surface of a hollow portion of the hollow foamed blow-molded article. Hereinafter, unless otherwise specified, the surface smoothness of the inner surface of the hollow portion of the hollow foamed blow-molded article is simply referred to as surface smoothness.

One of the objects of the present invention is to provide a method for producing a foamed blow-molded article excellent in cold-impact resistance, rigidity, and surface smoothness, and to provide a foamed blow-molded article excellent in cold-impact resistance, rigidity, and surface smoothness.

### Solution to Problem

The invention is summarized in aspects shown in the following (1) to (5).
(1) A method for producing a foamed blow-molded article, the method including:
a step of blow-molding a foamed parison obtained by foaming a mixed resin containing a polyolefin-based resin (A) and an olefin-based thermoplastic elastomer (B), in which
the polyolefin-based resin (A) contains a branched homopolypropylene (a1) and a linear block polypropylene (a2), and a mass ratio [(a1):(a2)] of the branched homopolypropylene (a1) to the linear block polypropylene (a2) is 50:50 to 93:7,
the olefin-based thermoplastic elastomer (B) is a hydrogenated product of a triblock copolymer containing a crystalline olefin polymer block and a polymer block of a conjugated diene compound, and
in the mixed resin, a blending amount of the olefin-based thermoplastic elastomer (B) with respect to 100 parts by mass of the polyolefin-based resin (A) is 20 parts by mass or more and 40 parts by mass or less.
(2) The method for producing a foamed blow-molded article according to (1), in which
the olefin-based thermoplastic elastomer (B) has a melting point of 80° C. or higher and 100° C. or lower.
(3) The method for producing a foamed blow-molded article according to (1) or (2), in which
the linear block polypropylene (a2) has a flexural modulus of 1000 MPa or higher and 1500 MPa or lower.
(4) The method for producing a foamed blow-molded article according to any one of (1) to (3), in which
the olefin-based thermoplastic elastomer (B) has a melt flow rate (at 230° C. and a load of 2.16 kg) of 1 g/10 min or more and 10 g/10 min or less.
(5) A foamed blow-molded article of a mixed resin containing a polyolefin-based resin (A) and an olefin-based thermoplastic elastomer (B), in which
the polyolefin-based resin (A) contains a branched homopolypropylene (a1) and a linear block polypropylene (a2), and a mass ratio [(a1):(a2)] of the branched homopolypropylene (a1) to the linear block polypropylene (a2) is 50:50 to 93:7,
the olefin-based thermoplastic elastomer (B) is a hydrogenated product of a triblock copolymer containing a crystalline olefin polymer block and a polymer block of a conjugated diene compound, and
in the mixed resin, a blending amount of the olefin-based thermoplastic elastomer (B) with respect to 100 parts by mass of the polyolefin-based resin (A) is 20 parts by mass or more and 40 parts by mass or less.

The present invention may also be aspects described in the following (6) to (8).
(6) The foamed blow-molded article according to (5), in which
the olefin-based thermoplastic elastomer (B) has a melting point of 80° C. or higher and 100° C. or lower.
(7) The foamed blow-molded article according to (5) or (6), in which
the linear block polypropylene (a2) has a flexural modulus of 1000 MPa or higher and 1500 MPa or lower.
(8) The foamed blow-molded article according to any one of (5) to (7), in which
the olefin-based thermoplastic elastomer (B) has a melt flow rate (at 230° C. and a load of 2.16 kg) of 1 g/10 min or more and 10 g/10 min or less.

### Advantageous Effects of Invention

According to the present invention, a method for producing a foamed blow-molded article excellent in cold-impact resistance, rigidity, and surface smoothness, and a foamed blow-molded article excellent in cold-impact resistance, rigidity, and surface smoothness can be provided.

### DESCRIPTION OF EMBODIMENTS

The present invention will be described in the order of 1 method for producing foamed blow-molded article and 2 foamed blow-molded article. The present invention is not limited to an embodiment to be described below.

### [1 Method for Producing Foamed Blow-Molded Article]

A production method according to the present invention is a method for producing a foamed blow-molded article including a blow-molding step. An example of the method for producing a foamed blow-molded article according to the present invention will be described.

### [1-1 Content of Production Method]

### (Extrusion-Foaming Step)

A mixed resin and a foaming agent are kneaded inside an extruder to obtain a foamable resin melt. The obtained foamable resin melt is extruded from a die connected to the extruder. Generally, an annular die is used as the die. A shaping mold is disposed immediately below the die, and the foamable resin melt is extruded into the shaping mold. At this time, the foamable resin melt is foamed to form a foamed parison. The shaping mold has a desired internal shape corresponding to a molded article desired to be obtained. Generally, the shaping mold is a split-type mold.

### (Pre-Blow Step)

Immediately after the extrusion-foaming step, the foamed parison is in a softened state. A lower portion of the foamed parison in a softened state is closed by using a pinch device or the like, and gas is blown into the foamed parison to increase internal pressure of the foamed parison. At this time, the foamed parison is widened. At a stage of the pre-blow step or after the pre-blow step, the foamed parison is sandwiched by the shaping mold.

### (Blow-Molding Step)

The blow-molding step is a step of blowing gas into the foamed parison in a state of sandwiching the foamed parison by the shaping mold. At this time, an outer surface of the foamed parison is pressed against an inner surface of the shaping mold, and the foamed parison is shaped into a hollow shape. By this step, a foamed blow-molded article is obtained. As the foamed blow-molded article, for example, a hollow molded article is obtained. In the method for producing a foamed blow-molded article, an accumulator is preferably provided between the extruder and the die or at the die.

### (Composition of Mixed Resin)

The mixed resin for forming the foamable resin melt is a mixed resin containing a polyolefin-based resin (A) and an olefin-based thermoplastic elastomer (B).

### (Polyolefin-Based Resin)

The polyolefin-based resin (A) is a resin composition containing a branched homopolypropylene (a1) and a linear block polypropylene (a2).

### (Branched Homopolypropylene)

The branched homopolypropylene (a1) is a homopolypropylene having a branched structure in its molecular structure. Examples of the branched structure include a structure portion that is branched in the molecular structure and has a long chain structure having a free end. The branched structure can be confirmed by using a high-temperature GPC-MALS measurement or the like.

The branched homopolypropylene (a1) has a melt flow rate that is measured under conditions of 230° C. and a load of 2.16 kg, being preferably 0.1 g/10 min to 15 g/10 min. In the case where the melt flow rate is within the above range, the resin is excellent in fluidity at the time of melting, and therefore drawdown of the foamed parison is further reduced. From this viewpoint, the melt flow rate of the branched homopolypropylene (a1) is more preferably 0.5 g/10 min to 10 g/10 min, and still more preferably 1 g/10 min to 5 g/10 min. The melt flow rate (MFR) of the resin can be measured by a known method, and for example, can be measured based on JIS K7210-1:2014 (test method A). Upper limit values and lower limit values in combinations defining respective numerical ranges shown above as numerical ranges of the melt flow rate of the branched homopolypropylene (a1) may be independently and freely combined. In this description, a combination defining a numerical range indicates a combination of an upper limit value and a lower limit value. The numerical range defined by freely combining the upper limit values and the lower limit values includes the upper limit value, the lower limit value, and values between the upper limit value and the lower limit value. Therefore, the numerical range of the melt flow rate of the branched homopolypropylene (a1) may be a numerical range in which the numerical values indicating the upper limit and the lower limit of the preferable numerical range and the numerical values indicating the upper limit and the lower limit of the still more preferable numerical range are combined. Specifically, examples of the numerical range of the melt flow rate of the branched homopolypropylene (a1) include a range in which any one selected from the group consisting of 0.1 g/10 min, 0.5 g/10 min, and 1 g/10 min is set as a lower limit value and any one selected from the group consisting of 15 g/10 min, 10 g/10 min, and 5 g/10 min is set as an upper limit value. Therefore, for example, the numerical range of the melt flow rate may be 0.1 g/10 min to 10 g/10 min, may be 0.5 g/10 min to 5 g/10 min, and may be 1 g/10 min to 15 g/10 min.

From a viewpoint of foamability in foam blow-molding, the branched homopolypropylene (a1) has a melt tension at 230° C. being preferably 5 cN to 50 cN, still more preferably 10 cN to 45 cN, and most preferably 25 cN to 40 cN. A numerical range of the melt tension of the branched homopolypropylene (a1) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the melt tension of the branched homopolypropylene (a1) at 230° C. include a range in which any one selected from the group consisting of 5 cN, 10 cN, and 25 cN is set as a lower limit value and any one selected from the group consisting of 50 cN, 45 cN, and 40 cN is set as an upper limit value. The melt tension (MT) of the branched homopolypropylene (a1) can be measured by a known method, and for example, can be measured by Capilograph 1D manufactured by Toyo Seiki Seisakusho Co., Ltd.

The branched homopolypropylene (a1) has a melting point of preferably 155° C. to 165° C., and more preferably 157° C. to 162° C. A numerical range of the melting point of the branched homopolypropylene (a1) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the melting point of the branched homopolypropylene (a1) include a range in which any one selected from the group consisting of 155° C. and 157° C. is set as a lower limit value and any one selected from the group consisting of 165° C. and 162° C. is set as an upper limit value. The melting point can be measured in the same manner as a melting point of the olefin-based thermoplastic elastomer (B) to be described later, based on JIS K7121:2012.

Since the branched homopolypropylene (a1) is excellent in foamability, in the case where the polyolefin-based resin (A) contains the branched homopolypropylene (a1), a foamed blow-molded article excellent in lightweight and surface smoothness is easily obtained. Specific examples of the branched homopolypropylene (a1) include an HMS-polypropylene and a UMS-polypropylene which are commercially available. Examples of the branched homopolypropylene (a1) include a branched homopolypropylene produced by Borealis (trade names: WB130, WB135, and WB140) and a branched homopolypropylene resin produced by SunAllomer (trade name: PF814).

### (Linear Block Polypropylene)

The linear block polypropylene (a2) is a block polypropylene having a linear molecular structure. Examples of the block polypropylene include a polymerized mixture obtained by polymerizing ethylene and one or more types of C3 to C10 α-olefins (α-olefins having 3 to 10 carbon atoms) in the presence of a propylene polymer. The linear block polypropylene (a2) includes an impact-resistant polypropylene polymer defined by JIS K6921-1, and generally includes those commercially available as a block polypropylene. The examples of the block polypropylene described here are examples, and other examples are not excluded. Specific examples of the block polypropylene include a propylene-ethylene block copolymer. More specifically, examples of the propylene-ethylene block copolymer include a block copolymer including a crystalline propylene block and an ethylene propylene random block.

### (Flexural Modulus of Linear Block Polypropylene)

The linear block polypropylene (a2) has a flexural modulus of preferably 1000 MPa or higher and 1500 MPa or lower. In the case where the flexural modulus of the linear block polypropylene (a2) is 1000 MPa or higher, the rigidity of the foamed blow-molded article can be more effectively improved, and a cushioning property of the foamed blow-molded article can also be improved. From this viewpoint, the flexural modulus of the linear block polypropylene (a2) is more preferably 1100 MPa or higher and 1400 MPa or lower. A numerical range of the flexural modulus of the linear block polypropylene (a2) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the flexural modulus of the linear homopolypropylene (a2) include a range in which any one selected from the group consisting of 1000 MPa and 1100 MPa is set as a lower limit value and any one selected from the group consisting of 1500 MPa and 1400 MPa is set as an upper limit value.

### (Measurement of Flexural Modulus)

The flexural modulus of the linear block polypropylene (a2) can be measured based on JIS K7171:2016.

The flexural modulus of the resin itself of the linear block polypropylene (a2) is generally and often less than that of the branched homopolypropylene (a1). Since the polyolefin-based resin (A) contains not only the branched homopolypropylene (a1) but also the linear block polypropylene (a2), the rigidity of the foamed blow-molded article can be improved. Since the polyolefin-based resin (A) contains the linear block polypropylene (a2), it is easy to obtain a foamed blow-molded article excellent in lightweight and excellent in surface smoothness.

The linear block polypropylene (a2) has a melt flow rate that is measured under conditions of 230° C. and a load of 2.16 kg, being preferably 1 g/10 min to 40 g/10 min. In the case where the melt flow rate is within the above range, the mixed resin is excellent in fluidity at the time of melting. From this viewpoint, the melt flow rate of the linear block polypropylene (a2) is more preferably 2 g/10 min to 38 g/10 min, further preferably 10 g/10 min to 35 g/10 min, and still more preferably 20 g/10 min to 33 g/10 min. A numerical range of the melt flow rate of the linear block polypropylene (a2) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the melt flow rate of the linear block polypropylene (a2) include a range in which any one selected from the group consisting of 1 g/10 min, 2 g/10 min, 10 g/10 min, and 20 g/10 min is set as a lower limit value and any one selected from the group consisting of 40 g/10 min, 38 g/10 min, 35 g/10 min, and 33 g/10 min is set as an upper limit value. The melt flow rate (MFR) of the resin can be measured by a known method, and for example, can be measured based on JIS K7210-1:2014 (test method A).

The linear block polypropylene (a2) has a melting point of preferably 155° C. to 169° C., and preferably 158° C. to 168° C. A numerical range of the melting point of the linear block polypropylene (a2) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the melting point of the linear block polypropylene (a2) include a range in which any one selected from the group consisting of 155° C. and 158° C. is set as a lower limit value and any one selected from the group consisting of 169° C. and 168° C. is set as an upper limit value. The melting point can be measured in the same manner as a melting point of the olefin-based thermoplastic elastomer (B) to be described later, based on JIS K7121:2012.

(Mass Ratio [(a1):(a2)])

In the mixed resin, a mass ratio [(a1):(a2)] of the branched homopolypropylene (a1) to the linear block polypropylene (a2) is preferably 50:50 to 93:7. In the case where the mass ratio [(a1):(a2)] is within the above numerical range, effects of improving the foamability of the mixed resin, improving the surface smoothness, and improving the rigidity and the cold-impact resistance of the foamed blow-molded article can be obtained. From a viewpoint of further improving these effects, the mass ratio [(a1):(a2)] is preferably 70:30 to 92:8, and more preferably 80:20 to 90:10. A numerical range of the mass ratio [(a1):(a2)] can be obtained by freely and independently combining ratios as the upper limit and ratios as the lower limit which are indicated in the combinations of the numerical ranges described above. The numerical range defined by freely combining the ratios as the upper limit and the ratios as the lower limit includes the ratio as the upper limit, the ratio as the lower limit, and ratios between the ratio as the upper limit and the ratio as the lower limit. However, in the combinations of the respective numerical ranges of the mass ratio [(a1):(a2)], a mass ratio at which the mass proportion of the branched homopolypropylene (a1) is the smallest is set as the ratio as a lower limit, and a mass ratio at which the mass proportion of the branched homopolypropylene (a1) is the largest is set as the ratio as an upper limit. For example, in the case where the numerical range of the mass ratio [(a1):(a2)] is 50:50 to 93:7, the ratio as a lower limit is 50:50, and the ratio as an upper limit is 93:7. Examples of the numerical range of the mass ratio [(a1):(a2)] include a range in which any one selected from the group consisting of 50:50, 70:30, and 80:20 is set as a lower limit and any one selected from the group consisting of 93:7, 92:8, and 90:10 is set as an upper limit.

### (Olefin-Based Thermoplastic Elastomer)

The olefin-based thermoplastic elastomer (B) is a hydrogenated product of a triblock copolymer including a hard segment of a polymer block of a crystalline olefin and a soft segment of a polymer block of a conjugated diene compound. The triblock copolymer is preferably a block copolymer having a so-called A-B-A type (sandwich type) structure. At this time, it is preferable that A as a block portion at both ends in the block copolymer having the A-B-A type structure is the polymer block of the crystalline olefin and B as a block portion (a central block portion) sandwiched between A's is the polymer block of the conjugated diene compound. In the case where the olefin-based thermoplastic elastomer (B) is the hydrogenated product of the block copolymer having the structure as described above, it is possible to improve the impact resistance of the foamed blow-molded article without inhibiting the foamability of the foamed parison. In addition, the effect of improving the surface smoothness of the foamed blow-molded article can be exhibited.

Examples of a polymer of the crystalline olefin include a polymer of ethylene. Examples of a polymer of the conjugated diene compound include polymers such as 1,3-butadiene, isoprene (2-methyl-1,3-butadiene), 1,3-pentadiene, and 2,3-dimethyl-1,3-butadiene, in addition to polymers of ethylene and butylene.

Specific examples of the olefin-based thermoplastic elastomer (B) include a hydrogenated product of a triblock copolymer having a block of the ethylene polymer as block portions at both ends and a block of the 1,3-butadiene polymer as a central block portion. Examples of the olefin-based thermoplastic elastomer (B) include a block copolymer of crystalline olefin ethylene butylene crystalline olefin in a state after hydrogenation. The olefin-based thermoplastic elastomer (B) does not contain polypropylene-based resins such as the branched homopolypropylene (a1) and the linear block polypropylene (a2).

### (Melting Point of Olefin-Based Thermoplastic Elastomer)

The olefin-based thermoplastic elastomer (B) has a melting point of preferably 80° C. or higher and 110° C. or lower. In the case where the melting point of the olefin-based thermoplastic elastomer (B) falls within the above range, foamability is excellent. From this viewpoint, the melting point of the olefin-based thermoplastic elastomer (B) is more preferably 85° C. or higher and 105° C. or lower, and still more preferably 90° C. or higher and 100° C. or lower. A numerical range of the melting point of the olefin-based thermoplastic elastomer (B) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the melting point of the olefin-based thermoplastic elastomer (B) include a range in which any one selected from the group consisting of 80° C., 85° C., and 90° C. is set as a lower limit value and any one selected from the group consisting of 110° C., 105° C., and 100° C. is set as an upper limit value.

### (Method of Measuring Melting Point)

The melting point of the olefin-based thermoplastic elastomer (B) can be specified as a melting peak temperature measured based on a heat flux differential scanning calorimetry described in JIS K7121:2012. As an adjustment of a test piece used for the heat flux differential scanning calorimetry, “(2) when measuring the melting temperature after performing a constant heat treatment” is employed, and a heating speed and a cooling speed are both employed at 10° C./min. In the case where a plurality of melting peaks appear in a DSC curve, an apex temperature of the melting peak having the largest area is taken as the melting point.

### (Flexural Modulus of Olefin-Based Thermoplastic Elastomer)

An upper limit of the flexural modulus of the olefin-based thermoplastic elastomer (B) is preferably 50 MPa. In the case where the flexural modulus of the olefin-based thermoplastic elastomer (B) is 50 MPa or lower, the olefin-based thermoplastic elastomer (B) can effectively exhibit physical properties as an elastomer. A lower limit of the flexural modulus of the olefin-based thermoplastic elastomer (B) is preferably about 1 Ma. That is, the flexural modulus of the olefin-based thermoplastic elastomer (B) is preferably 1 MPa or higher and 50 MPa or lower. In the case where the flexural modulus of the olefin-based thermoplastic elastomer (B) is in the above numerical range, an effect of further improving the cold-impact resistance as the foamed blow-molded article can be easily obtained. From a viewpoint of further improving this effect, the flexural modulus of the olefin-based thermoplastic elastomer (B) is more preferably 3 MPa or higher and 30 MPa or lower, and still more preferably 5 MPa or higher and 25 MPa or lower. A numerical range of the flexural modulus of the olefin-based thermoplastic elastomer (B) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the flexural modulus of the olefin-based thermoplastic elastomer (B) include a range in which any one selected from the group consisting of 1 MPa, 3 MPa, and 5 MPa is set as a lower limit value and any one selected from the group consisting of 50 MPa, 30 MPa, and 25 MPa is set as an upper limit value.

### (Measurement of Flexural Modulus)

The flexural modulus of the olefin-based thermoplastic elastomer (B) can be measured based on JIS K7171:2016.

### (Melt Flow Rate (MFR) of Olefin-Based Thermoplastic Elastomer)

The olefin-based thermoplastic elastomer (B) has an MFR (230° C., load of 2.16 kg) of preferably 1 g/10 min or more and 10 g/10 min or less, and more preferably 1.5 g/10 min or more and 5 g/10 min or less. A numerical range of the MFR of the olefin-based thermoplastic elastomer (B) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the MFR of the olefin-based thermoplastic elastomer (B) include a range in which any one selected from the group consisting of 1 g/10 min and 1.5 g/10 min is set as a lower limit value and any one selected from the group consisting of 10 g/10 min and 5 g/10 min is set as an upper limit value.

### (Measurement of MFR)

The MFR (g/10 min (230° C.)) of the olefin-based thermoplastic elastomer (B) can be determined based on, for example, JIS K7210-1:2014 (test method A). As measurement conditions, conditions of 230° C. and a load of 2.16 kg may be employed.

### (Blending Rate of Each Component of Mixed Resin)

In the mixed resin, the blending amount of the olefin-based thermoplastic elastomer (B) with respect to 100 parts by mass of the polyolefin-based resin (A) is 20 parts by mass or more and 40 parts by mass or less. In the case where the blending amount of the olefin-based thermoplastic elastomer (B) with respect to 100 parts by mass of the polyolefin-based resin (A) falls within the above range, it is easy to achieve both the impact resistance and the surface smoothness required for the foamed blow-molded article. From the above viewpoint, the blending amount of the olefin-based thermoplastic elastomer (B) is preferably 22 parts by mass or more and 35 parts by mass or less, and more preferably 23 parts by mass or more and 30 parts by mass or less.

The mass ratio of the olefin-based thermoplastic elastomer (B) with respect to the branched homopolypropylene (a1) in the polyolefin-based resin (A) is preferably 0.2 to 0.5, and more preferably 0.25 to 0.35. The mass ratio of the olefin-based thermoplastic elastomer (B) with respect to the linear block polypropylene (a2) in the polyolefin-based resin (A) is preferably from 1.0 to 2.5, and more preferably from 1.2 to 2.3. In the case where the mass ratio of the olefin-based thermoplastic elastomer (B) with respect to the branched homopolypropylene (a1) falls within the above range, the impact resistance can be easily exhibited. The mass ratio of the olefin-based thermoplastic elastomer (B) with respect to the branched homopolypropylene (a1) is a value (a divided value) obtained by dividing “the blending amount (parts by mass) of the olefin-based thermoplastic elastomer (B)” by “the blending amount (parts by mass) of the branched homopolypropylene (a1)”, used in the mixed resin. The mass ratio of the olefin-based thermoplastic elastomer (B) with respect to the linear block polypropylene (a2) is a value (a divided value) obtained by dividing “the blending amount (parts by mass) of the olefin-based thermoplastic elastomer (B)” by “the blending amount (parts by mass) of the linear block polypropylene (a2)”, used in the mixed resin.

In the mixed resin, in addition to the numerical range of the blending amount of the olefin-based thermoplastic elastomer (B) with respect to 100 parts by mass of the polyolefin-based resin (A), at least one type of numerical range selected from the numerical range of the mass ratio of the olefin-based thermoplastic elastomer (B) with respect to the branched homopolypropylene (a1) in the polyolefin-based resin (A) and the numerical range of the mass ratio of the olefin-based thermoplastic elastomer (B) with respect to the branched homopolypropylene (a2) may satisfy the above numerical values. It is preferable that the numerical range for either of the two types satisfies the above respective numerical values.

A numerical range of the blending amount of the olefin-based thermoplastic elastomer (B) with respect to 100 parts by mass of the polyolefin-based resin (A) can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the blending amount of the olefin-based thermoplastic elastomer (B) with respect to 100 parts by mass of the polyolefin-based resin (A) include a range in which any one selected from the group consisting of 20 parts by mass, 22 parts by mass, and 23 parts by mass is set as a lower limit value and any one selected from the group consisting of 40 parts by mass, 35 parts by mass, and 30 parts by mass is set as an upper limit value. A numerical range of the mass ratio of the olefin-based thermoplastic elastomer (B) with respect to the branched homopolypropylene (a1) in the polyolefin-based resin (A) and the numerical range of the mass ratio of the olefin-based thermoplastic elastomer (B) with respect to the branched homopolypropylene (a2) can be obtained by freely and independently combining the upper limit values and the lower limit values indicated in the combinations of the numerical ranges respectively described above. Also in this case, the numerical range defined by freely combining the upper limit values and the lower limit values includes the upper limit value, the lower limit value, and values between the upper limit value and the lower limit value. Examples of the numerical range of the mass ratio of the olefin-based thermoplastic elastomer (B) with respect to the branched homopolypropylene (a1) in the polyolefin-based resin (A) include a range in which any one selected from the group consisting of 0.2 and 0.25 is set as a lower limit value and any one selected from the group consisting of 0.5 and 0.35 is set as an upper limit value.

### (Other Additives in Mixed Resin)

When the foamed blow-molded article is produced, the mixed resin and a foaming agent are kneaded as described above. Examples of a physical foaming agent include the followings.

### (Foaming Agent)

Examples of the foaming agent include organic physical foaming agents such as aliphatic hydrocarbons such as propane, normal butane, isobutane, normal pentane, isopentane, normal hexane, isohexane, and cyclohexane, chlorinated hydrocarbons such as methyl chloride and ethyl chloride, fluorinated hydrocarbons such as 1,1,1,2-tetrafluoroethane and 1,1-difluoroethane, aliphatic ethers such as dimethyl ether, diethyl ether, and methyl ethyl ether, aliphatic alcohols such as methyl alcohol and ethyl alcohol, and dialkyl carbonates such as dimethyl carbonate and diethyl carbonate, inorganic physical foaming agents such as carbon dioxide, nitrogen, air, and water, and chemical foaming agents such as sodium bicarbonate, sodium citrate, and azodicarbonamide. These foaming agents are used alone or in combination.

In the case where the foamed parison is formed by using the inorganic physical foaming agent, the foaming of the foamable resin melt is completed early, and little or no foaming agent remains in the resin constituting the foamed parison. Therefore, the resin constituting the foamed parison is not plasticized, and the drawdown of the foamed parison is prevented. As a result, a foamed parison excellent in blow mold ability as compared with a parison obtained by using the organic physical foaming agent, can be obtained. From this viewpoint, it is preferable to use the inorganic physical foaming agent among the above-described foaming agents, more preferable to use the inorganic physical foaming agent including carbon dioxide, and still more preferable to use a physical foaming agent including only carbon dioxide.

In the present invention, in the case where a foaming agent including carbon dioxide is used as the physical foaming agent, the carbon dioxide is preferably blended in an amount of 20 mol % to 100 mol %, more preferably 50 mol % to 100 mol %, and still more preferably 70 mol % to 100 mol % with respect to 100 mol % of the physical foaming agent. In the case where the content of the carbon dioxide is within the above range, a foamed blow-molded article having a small cell diameter and a high closed cell ratio can be easily obtained.

An addition amount of the physical foaming agent is preferably 0.05 mol to 0.8 mol, and more preferably 0.1 mol to 0.5 mol, per 1 kg of the mixed resin.

### (Other Resins)

The mixed resin may contain other resins that are different from the polyolefin-based resin (A) and the olefin-based thermoplastic elastomer (B) in a range of not impairing the effects of the invention. As other resins, a thermoplastic resin such as a polystyrene-based resin and a polystyrene-based resin other than the polyolefin-based resin (A), or a thermoplastic elastomer (TPE) other than the olefin-based thermoplastic elastomer (B) may be contained. As the polyolefin-based resin other than the polyolefin-based resin (A), a biomass polyolefin-based resin, a polyolefin-based resin derived from ASR, and a mass balance polyolefin-based resin may be used. A blending amount of other resins is preferably 30 parts by mass or less, more preferably 20 parts by mass or less, still more preferably 10 parts by mass or less, and particularly preferably 5 parts by mass or less with respect to 100 parts by mass of the total of the polyolefin-based resin (A) and the olefin-based thermoplastic elastomer (B).

### (Various Additives)

When the foamed blow-molded article is produced, various additives may be added to the mixed resin in addition to the above foaming agent. Examples of the additives include flame retardants, flow control agents, ultraviolet absorbers, conductivity imparting agents, antistatic agents, colorants, heat stabilizers, antioxidants, inorganic fillers, and pigments. The blending amount of the above additives is preferably 10 parts by mass or less, more preferably 5 parts by mass or less, and still more preferably 3 parts by mass or less with respect to 100 parts by mass of the total of the polyolefin-based resin (A) and the olefin-based thermoplastic elastomer (B). The above additives may be added to the polyolefin-based resin (A), the olefin-based thermoplastic elastomer (B), the branched homopolypropylene (a1), and the linear block polypropylene (a2) within a range of not impairing functions and effects of the invention. Preferably, the addition amount thereof is preferably 10 parts by mass or less, more preferably 5 parts by mass or less, and still more preferably 3 parts by mass or less, with respect to 100 parts by mass of each of the polyolefin-based resin (A), the olefin-based thermoplastic elastomer (B), the branched homopolypropylene (a1), and the linear block polypropylene (a2).

Carbon black may be added to the mixed resin as the additive. The content of carbon black in the mixed resin is preferably 0.1 parts by mass or more and 2 parts by mass or less, and more preferably 0.3 parts by mass or more and 1 part by mass or less with respect to 100 parts by mass of the total of the polyolefin-based resin (A) and the olefin-based thermoplastic elastomer (B). Examples of carbon black include gas furnace black, oil furnace black, acetylene black, channel black, roller black, thermal black, and Ketjen black. In the case where a recovered raw material containing carbon black is used as a part of a raw material when producing the foamed blow-molded article, a total content of carbon black in the mixed resin is a value containing carbon black in the recovered raw material. A numerical range of the above-described physical foaming agent and a numerical range of various additives such as carbon black in the mixed resin can be obtained by freely and independently combining the upper limit values and the lower limit values indicated in the combinations of the numerical ranges respectively described above. The numerical range defined by freely combining the upper limit values and the lower limit values includes the upper limit value, the lower limit value, and values between the upper limit value and the lower limit value.

### (Use of Recycled Material (Recovered Raw Material))

When the foamed blow-molded article of the present invention is produced, a burr, a defective molded article in which a dimensional deviation or the like occurs, or the like may occur. These burr and defective molded article can be used as the recovered raw material. The recovered raw material preferably contains the polyolefin-based resin (A) and the olefin-based thermoplastic elastomer (B). In the method for producing a foamed blow-molded article according to the present invention, a foamable resin melt containing the recovered raw material may be formed, and a foamed blow-molded article may be formed by a foamed parison obtained by foaming the foamable resin melt. In the case where the recovered raw material containing the polyolefin-based resin (A) and the olefin-based thermoplastic elastomer (B) is used as a part of the raw material when forming the foamable resin melt, the blending amounts of the polyolefin-based resin (A) and the olefin-based thermoplastic elastomer (B) in the mixed resin forming the foamed blow-molded article are determined as values containing the polyolefin-based resin (A) and the olefin-based thermoplastic elastomer (B) contained in the recovered raw material. Numerical ranges regarding attributes such as physical properties of the polyolefin-based resin (A) and the olefin-based thermoplastic elastomer (B) contained in the recovered raw material, and numerical ranges of the blending amounts of the polyolefin-based resin (A) and the olefin-based thermoplastic elastomer (B) are the same as those described above for the polyolefin-based resin (A) and the olefin-based thermoplastic elastomer (B) constituting the mixed resin forming the foamed blow-molded article.

### [1-2 Effects of Method for Producing Foamed Blow-Molded Article]

The foamed blow-molded article using the polypropylene-based resin is particularly excellent in terms of heat resistance and lightweight and can be suitably employed for use in a duct mounted on a vehicle such as an automobile. In recent years, the foamed blow-molded article suitably used in such an application has been further required to have improved cold-impact resistance.

However, when an elastomer is added to the polypropylene-based resin to improve the cold-impact resistance of the foamed blow-molded article, the rigidity of the foamed blow-molded article is likely to decrease. In the case where the foamed blow-molded article is used as a duct, if the rigidity of the foamed blow-molded article decreases, when negative pressure is generated inside the duct when gas such as air passes through the duct, a surface portion of the foamed blow-molded article forming the duct may curve slightly inward.

In the case where the foamed blow-molded article is formed in a hollow shape and used as a duct, from the viewpoint of reducing air resistance of the duct and reducing a ventilation sound (wind noise), it is required to improve the surface smoothness of an inner surface of the hollow portion of the foamed blow-molded article.

According to the method for producing a foamed blow-molded article in the present invention, since a specific polypropylene-based resin (the polyolefin-based resin (A)) and a specific elastomer (the olefin-based thermoplastic elastomer (B)) are used in a specific range, a foamed blow-molded article excellent in both cold-impact resistance and rigidity can be obtained. In the method for producing the foamed blow-molded article, the foamability of the polyolefin-based resin (A) forming the foamable resin melt is not largely inhibited since the specific elastomer as described above is used, and therefore it is possible to reduce the possibility of deterioration of the surface smoothness of the foamed blow-molded article.

In addition, by using not only the branched homopolypropylene but also the linear polypropylene block in combination in a specific range as the polyolefin-based resin, it is possible to reduce the possibility of a decrease in the rigidity of the foamed blow-molded article due to the use of elastomer and to obtain a foamed blow-molded article excellent in the rigidity.

In addition, the foamed blow-molded article is required to have various apparent densities depending on various conditions such as applications. According to the method for producing a foamed blow-molded article according to the present invention, by using a specific polypropylene-based resin and a specific elastomer in a specific blending ratio, a foamed blow-molded article excellent in surface smoothness (excellent in inner surface smoothness) can be obtained even under conditions for obtaining various apparent densities. Attributes such as the apparent density, the closed cell ratio, and the flexural modulus related to the foamed blow-molded article obtained by applying the method for producing a foamed blow-molded article according to the present invention will be described in [2. Foamed Blow-Molded Article].

Next, a foamed blow-molded article according to the present invention will be described.

### [2. Foamed Blow-Molded Article]

### [2-1 Configuration of Foamed Blow-Molded Article]

The foamed blow-molded article according to the present invention is a foamed molded article of the mixed resin of the polyolefin-based resin (A) and the olefin-based thermoplastic elastomer (B).

The foamed blow-molded article according to the present invention can be obtained by the method for producing a foamed blow-molded article described above. That is, the foamed blow-molded article can be obtained by performing the extrusion foaming step, the pre-blow step, and the blow-molding step in the same manner as described in [1. Method for Producing Foamed Blow-Molded Article]. The respective steps are the same as those described in [1.

Method for Producing Foamed Blow-Molded Article], and therefore description thereof is omitted.

The polyolefin-based resin (A) blended in the mixed resin used in the foamed blow-molded article according to the present invention contains the branched homopolypropylene (a1) and the linear block polypropylene (a2) in a predetermined mass ratio [(a1):(a2)]. Structures, physical properties (the melt flow rate, the melting point, the flexural modulus, and the like), and the mass ratio [(a1):(a2)] of the branched homopolypropylene (a1) and the linear block polypropylene (a2) are the same as those described in [1. Method for Producing Foamed Blow-Molded Article], and therefore description thereof is omitted. As the polyolefin-based resin (A), use can be made of polypropylene derived from biomass or polypropylene derived from a mass balance method.

Structures and physical properties (the melt flow rate, the melting point, and the like) of the olefin-based thermoplastic elastomer (B) blended in the mixed resin used in the foamed blow-molded article and the blending amount of the olefin-based thermoplastic elastomer (B) with respect to 100 parts by mass of the polyolefin-based resin (A) in the mixed resin are the same as those described in [1. Method for Producing Foamed Blow-Molded Article], and therefore description thereof is omitted.

### (Shape of Foamed Blow-Molded Article)

The shape of the foamed blow-molded article is not particularly limited, and the foamed blow-molded article can be easily used as air conditioning ducts provided in a vehicle or the like in the case of being a hollow molded article.

### (Closed Cell Ratio)

The closed cell ratio of the foamed blow-molded article is preferably 65% or more and more preferably 70% or more from the viewpoint of improving appearance.

### (Measurement of Closed Cell Ratio)

A test piece is prepared by cutting a roughly flat part of the foamed blow-molded article into a piece of 25 mm×25 mm×a thickness of the flat part. A plurality of test pieces are stacked such that a total thickness is closest to 20 mm to obtain a measurement test piece. Next, according to a procedure C of ASTM-D2856-70, a true volume Vx of the measurement test piece is measured by using an air comparison pycnometer model 930 of Toshiba Beckman Co., Ltd. or the like, and a closed cell ratio S (%) is calculated by the following formula (Formula (1)). The measurement described above is performed by using five of the measurement test pieces, and an arithmetic mean value thereof is defined as the closed cell ratio of the foamed blow-molded article.

$$\begin{matrix}[ Math . 1 ] & \\ S ( \% ) = ( Vx - W / ρ ) \times 100 / ( Va - W / ρ ) & ( 1 )\end{matrix}$$

Here,
Vx: a true volume (cm³) of the test piece measured by the above method, which corresponds to a sum of the volume of the resin forming the foamed blow-molded article and the total volume of cells in closed cell portions in the test piece,
Va: an apparent volume (cm³) of the test piece calculated from the outer dimension of the test piece used in the measurement,
W: a total mass (g) of the test pieces used in the measurement, and
ρ: a density (g/cm³) of the resin forming the foamed blow-molded article.

### (Apparent Density)

The apparent density of the foamed blow-molded article is preferably 100 kg/m³ or more and 450 kg/m³ or less. By having the apparent density described above, a molded article that is lightweight and has appropriate rigidity can be stably obtained. From the viewpoint of a balance between lightweight, rigidity, and cushioning property, the apparent density of the foamed blow-molded article is preferably 120 kg/m³ or more and 400 kg/m³ or less, more preferably 130 kg/m³ or more and 350 kg/m³ or less, and still more preferably 150 kg/m³ or more and 250 kg/m³ or less. A numerical range of the apparent density of the foamed blow-molded article can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the apparent density of the foamed blow-molded article include a range in which any one selected from the group consisting of 100 kg/m³, 120 kg/m³, 130 kg/m³, and 150 kg/m³ is set as a lower limit value and any one selected from the group consisting of 450 kg/m³, 400 kg/m³, 350 kg/m³, and 250 kg/m³ is set as an upper limit value.

### (Measurement of Apparent Density)

For vertical cross sections with respect to a longitudinal direction of the foamed blow-molded article at three locations in total, that is, in the vicinity of a center part in the longitudinal direction and both end portions in the longitudinal direction, four equally spaced locations were selected on a flat portion in a peripheral direction of each of vertical cross sections, and test pieces having an area of approximately 10 cm² in a plan view was cut out therefrom. For each of the test pieces, a mass Wi [g] was divided by a volume Vi [cm³] to obtain an apparent density (Wi/Vi) of each of the test pieces by unit conversion, and an arithmetic mean value of these values was defined as the apparent density (D).

### (Flexural Modulus of Foamed Blow-Molded Article)

The flexural modulus (MPa) of the foamed blow-molded article is preferably 140 MPa or higher and 250 MPa or lower. In the case where the flexural modulus of the foamed blow-molded article is in the above numerical range, sufficient rigidity is easily ensured. From the viewpoint of further improving this effect, the flexural modulus of the foamed blow-molded article is more preferably 150 MPa or higher and 200 MPa or lower. A numerical range of the flexural modulus of the foamed blow-molded article can be obtained by freely and independently combining the upper limit values and the lower limit values indicated in the combinations of the numerical ranges described above. The numerical range defined by freely combining the upper limit values and the lower limit values includes the upper limit value, the lower limit value, and values between the upper limit value and the lower limit value. Examples of the numerical range of the flexural modulus of the foamed blow-molded article include a range in which any one selected from the group consisting of 140 MPa and 150 MPa is set as a lower limit value and any one selected from the group consisting of 250 MPa and 200 MPa is set as an upper limit value.

### (Measurement of Flexural Modulus of Foamed Blow-Molded Article)

The flexural modulus of the foamed blow-molded article can be specified by cutting out a sample from a flat portion of the foamed blow-molded article and measuring a flexural modulus of the sample piece based on JIS K7171:2016.

### [2-2 Effects of Foamed Blow-Molded Article]

The foamed blow-molded article according to the present invention is a foamed molded article of the mixed resin in which a specific polypropylene-based resin (the polyolefin-based resin (A)) and a specific elastomer (the olefin-based thermoplastic elastomer (B)) are blended in a specific range, and therefore is excellent in both cold-impact resistance and rigidity, in the same manner as described in [1. Method for Producing Foamed Blow-Molded Article]. In addition, since the foamed blow-molded article is formed of a specific elastomer, the surface smoothness is excellent.

By using not only the branched homopolypropylene but also the linear polypropylene block in combination in a specific range as the polyolefin-based resin (A), it is possible to prevent a decrease in the rigidity of the foamed blow-molded article due to the use of elastomer. Therefore, the foamed blow-molded article according to the present invention is excellent in rigidity.

In addition, the foamed blow-molded article is required to have various apparent densities depending on various conditions such as applications. In the foamed blow-molded article according to the present invention, a specific polypropylene-based resin and a specific elastomer are used in a specific range, and excellent surface smoothness can be obtained even when the apparent density of the foamed blow-molded article has various values.

The above-described cold-impact resistance of the foamed blow-molded article can be specified by the following (−10° C. falling ball test).

(−10° C. Falling Ball Test (1.5 m, 1 kg))

A state of the foamed blow-molded article is adjusted by placing the foamed blow-molded article in an atmosphere of −10° C. for 24 hours. The foamed blow-molded article whose state is adjusted is placed on a test bench with a flat portion facing upward, and an iron ball of 1 kg is dropped onto the flat portion from 1.5 m above. At this time, a damaged state of the foamed blow-molded article is observed. The less a degree of damage to the foamed blow-molded article is (including a case in which there is no damage), the more excellent the cold-impact resistance of the foamed blow-molded article can be evaluated.

When the iron ball collides with the foamed blow-molded article, if a force is applied to a place separated from the flat portion and the foamed blow-molded article is damaged, the above-described −10° C. falling ball test is preferably performed again.

Next, further details will be described with reference to Examples.

### EXAMPLES

### (Preparation of Resin)

Polyolefin-based resins and elastomers indicated in Table 1 were prepared. Here, as the polyolefin-based resins, a branched homopolypropylene (a1), a linear block polypropylene (a2), and a linear homopolypropylene were prepared. Table 1 also indicates physical properties (MFR (g/10 min (230° C., load of 2.16 kg)) and flexural modulus (MPa)) of the prepared polyolefin-based resins and elastomers.

The MFR (g/10 min (230° C., load of 2.16 kg)) and the flexural modulus (MPa) of the polyolefin-based resins and the elastomers can be specified by applying the same methods as the methods described above for the polyolefin-based resin (A) and the olefin-based thermoplastic elastomer (B). Regarding the melting points (C) of the branched homopolypropylene (a1) and the elastomers to be described later, as a method for specifying the melting points, the method described above for the olefin-based thermoplastic elastomer (B) is used. Crystallization temperatures (° C.) of the branched homopolypropylene (a1) and the elastomers are measured based on JIS K 7121: 1987 by using a heat flux differential scanning calorimeter. In the case where a plurality of crystallization peaks appear in a differential scanning calorimetry (DSC) curve, a peak temperature of a crystallization peak having the highest peak height is taken as the crystallization temperature.

As the branched homopolypropylene (a1), a trade name of “WB140” (produced by Borealis) (melt tension (230° C.) was 36 cN, a melting point was 159° C., and a crystallization temperature was 129° C.) was prepared. In Tables 2, 3, and 4, the prepared branched homopolypropylene is abbreviated as WB140.

As the linear block polypropylene (a2), L-PP1 to L-PP3 indicated in Table 1 were prepared.

L-PP1 is a copolymer of propylene and ethylene (propylene-ethylene copolymer) (trade name “NOVATEC (registered trademark) PP (model number BC03GS)” produced by Japan Polypropylene Corporation). The propylene-ethylene copolymer of L-PP1 is a copolymer by a Ziegler catalyst (MFR is 30 g/10 min).

L-PP2 is a polypropylene block copolymer (MFR is 2.5 g/10 min) produced by Japan Polypropylene Corporation under a trade name “NOVATEC PP (model number BC6DRF)”.

L-PP3 is a propylene block copolymer containing an ethylene-α-olefin copolymer (MFR is 15 g/10 min) (trade name “Qualia (registered trademark) (model number CM 688A)” produced by SunAllomer Co., Ltd.). The MFR of the propylene block copolymer of L-PP3 is 9.5 g/10 min.

In Tables 2, 3, and 4, the linear block polypropylene indicated as L-PP1, L-PP2, and L-PP3 is abbreviated as BC03GS, BC6DRF, and CM688A, respectively.

As the linear homopolypropylene, a trade name “Prime Polypro (registered trademark) (model number J106G)” produced by Prime Polymer Co., Ltd was prepared. In Table 4, the prepared linear homopolypropylene is abbreviated as J106G.

As the elastomer, olefin-based elastomers indicated as EL1 to EL4 and a styrene-based elastomer indicated as EL5 were prepared.

EL1 is a hydrogenated product of a triblock copolymer containing a crystalline olefin polymer block and a polymer block of a conjugated diene compound. As EL1, a hydrogenated product of a block copolymer having an ethylene polymer block as block portions at both ends and a polymer block of a conjugated diene compound as a central block portion (produced by JSR Co., Ltd, trade name “DYNARON (registered trademark) 6200P”) (a component derived from ethylene in the block copolymer was 30 mass %, a component derived from 1,3-butadiene was 70 mass %, a hydrogenation rate (hydrogen addition ratio) was 98% or more, a melting point was 97° C., and a crystallization temperature was 64° C.) was prepared. EL1 corresponds to the olefin-based thermoplastic elastomer (B).

EL2 is a metallocene-based propylene-ethylene copolymer (produced by Exxon Mobil Corporation, a trade name “Vistamaxx (registered trademark) 6202, and a melting point of 102° C.”). EL3 is an RPTO (reactor TPO (thermoplastic olefinic elastomer) (produced by Basell Co., Ltd., a trade name “Catalloy (model number Q100F)”, a melting point of 143° C., and a crystallization temperature of 96° C.). The RPTO is a propylene-based random block copolymer sequentially polymerized with a Ziegler catalyst. EL4 is an ethylene-butene block copolymer (produced by Mitsui Chemicals, Inc., a trade name “TAFMER (registered trademark) (model number DF605)”, a melting point of 50° C. or less).

EL5 was a hydrogenated product of a styrene-based thermoplastic elastomer obtained by hydrogenating a double bond portion of a block copolymer formed of styrene and butadiene (produced by Asahi Kasei Corporation, trade name “TUFTEC (registered trademark) (model number H1041)”).

In Tables 2, 3, and 4, the elastomers indicated as EL1, EL2, EL3, EL4, and EL5 are abbreviated as 6200P, 6202, Q100F, DF605, and H1041, respectively.

TABLE 1

| | | | | MFR | Flexural |
|---|---|---|---|---|---|
| Type | | | Abbreviation | (g/10 min) | modulus (MPa) |
| Polyolefin- | Branched homopolypropylene (a1) | | WB140 | 2.1 | 1900 |
| based resin | Linear block | L-PP1 | BC03GS | 30 | 1400 |
| | polypropylene | L-PP2 | BC6DRF | 2.5 | 1100 |
| | (a2) | L-PP3 | CM688A | 9.5 | 1100 |
| | Linear homopropylene | | J106G | 15 | — |
| Elastomer | Olefin-based | EL1 | 6200P | 2.5 | 6 |
| | | EL2 | 6202 | 20 | 14 |
| | | EL3 | Q100F | 0.6 | 113 |
| | | EL4 | DF605 | 0.9 | 7 |
| | Styrene-based | EL5 | H1041 | 4.5 | — |

### Examples 1 to 5 and Comparative Examples 1 to 9

### (Extrusion-Foaming Step)

Polyolefin-based resins, elastomers, and additives to be described later of types and blending amounts (mass %) indicated in Table 2 (Examples 1 to 5), Table 3 (Comparative Examples 1 to 4), and Table 4 (Comparative Examples 5 to 9) were supplied to an extruder having a diameter of 65 mm and melted and kneaded in the extruder to obtain a resin melt. Carbon dioxide (CO₂) was injected into the extruder as a foaming agent and kneaded with the resin melt to obtain a foamable resin melt. The foamable resin melt was filled in an accumulator connected to the extruder. Then, at a foaming temperature of 170° C., the foamable resin melt was extruded into a constant pressure region from an annular die disposed at a tip of the accumulator and foamed to form a cylindrical foamed parison.

### (Pre-Blow Step)

A two-part mold was disposed directly below the annular die as a shaping mold, and the cylindrical foamed parison formed in the extrusion foaming step was placed between the mold. Then, after an opening of the foamed parison was closed on a lower side of the mold by using a pinch, pre-blow air was blown into the foamed parison, and the two-part mold was closed such that the foamed parison was sandwiched between the shaping mold.

### (Blow-Molding Step)

Blow air was blown from a blow pin into the foamed parison sandwiched between the shaping mold, and a space between an outer surface of the foamed parison and an inner surface of the mold was decompressed by a suction through holes provided in the mold, thereby pressing the outer surface of the foamed parison against the inner surface of the shaping mold. Then, the foamed parison was shaped into a shape corresponding to the inner surface of the mold. After the shaping and cooling, the mold which was the shaping mold was opened to take out the molded article, and burrs and pocket portions were removed. Accordingly, a foamed blow-molded article was obtained. The obtained foamed blow-molded article was formed in a hollow shape, and was formed in a shape corresponding to a duct having a substantially rectangular cross section, a maximum length of 650 mm, and a maximum width of 180 mm. A portion of the foamed blow-molded article formed into a hollow shape may particularly be referred to as a hollow portion.

Descriptions (description of abbreviations) of types of the polyolefin-based resins and the elastomers indicated in Tables 2, 3, and 4 (“type” column) correspond to types of the polyolefin-based resins and the elastomers indicated in Table 1. In Tables 2, 3, and 4, numerical values indicated in columns immediately below the descriptions of the types of the polyolefin-based resins correspond to the blending ratios (mass %) of the branched polypropylene and the linear polypropylene in the polyolefin-based resin when the total of the branched polypropylene and the linear polypropylene is taken as 100. Numerical values indicated in columns immediately below the description of the type of the elastomer corresponds to the blending amount (parts by mass) of the elastomer with respect to 100 parts by mass of the polyolefin-based resin.

A carbon black master batch (45% master batch (MB)) and a talc master batch (20% master batch (MB)) were added to the mixed resin so as to contain carbon black of 0.9 parts by mass and talc of 2 parts by mass as additives, with respect to the total 100 parts by mass of the polyolefin-based resin (A) and the olefin-based thermoplastic elastomer (B). The carbon black master batch is a trade name “PP Black Master Batch, BT920F-JSJ” produced by B & Tech Corporation. The talc master batch is a trade name of “Hifiller #12” (talc concentration is 20 mass %, and a median diameter is 7.5 μm) produced by Matsumura Sangyo Co., Ltd. The talc can function as a cell regulator.

The injection amount (mol/kg) of the foaming agent is as indicated in Tables 2, 3, and 4. The injection amount of the foaming agent indicated in Tables 2, 3, and 4 is an amount (mol/kg) per 1 kg of the mixed resin of the polyolefin-based resin and the elastomer.

### (Physical Properties of Foamed Blow-Molded Article)

Apparent density (kg/m³), thickness (mm), closed cell ratio (%), and flexural modulus (MPa) were measured as physical properties of the respective foamed blow-molded articles obtained in Examples 1 to 5 and Comparative Examples 1 to 9. Results are indicated in Tables 2, 3, and 4.

The apparent density, the closed cell ratio, and the flexural modulus of the foamed blow-molded article were measured by the above-described methods.

### (Thickness of Foamed Blow-Molded Article)

The thickness of the foamed blow-molded article indicates an average thickness of the foamed blow-molded article and is a value obtained by measurement by the following method. Vertical cross sections of the foamed blow-molded article with respect to the longitudinal direction are obtained at five locations in total, that is, in the vicinity of the center part in the longitudinal direction, both end portions in the longitudinal direction, and middle portions between the center part and both end portions. The thickness (wall thickness) of the foamed blow-molded article was measured at six equally spaced locations in a peripheral direction of each vertical cross section, and an arithmetic mean value of the thickness at 28 locations, excluding a maximum value and a minimum value from the obtained thickness measurement values at 30 locations, was taken as the average thickness of the foamed blow-molded article.

### (Evaluation of Foamed Blow-Molded Article)

The foamed blow-molded articles obtained in Examples 1 to 5 and Comparative Examples 1 to 9 were evaluated for cold-impact resistance and surface smoothness. Results are indicated in Tables 2, 3, and 4.

### (Cold-Impact Resistance)

The cold-impact resistance of the foamed blow-molded article was evaluated by performing a −10° C. falling ball test (1.5 m, 1 kg).

(−10° C. Falling Ball Test (1.5 m, 1 kg))

The foamed blow-molded article was placed in an atmosphere at −10° C. for 24 hours to perform state adjustment. The foamed blow-molded article subjected to the state adjustment was placed on a test bench with a flat portion facing upward, an iron ball of 1 kg was dropped from 1.5 m above toward the flat portion, and degree of damage to the foamed blow-molded article was observed. The falling ball test was performed five times. In the case where the flat part (flat portion) of the foamed blow-molded article that was hit by the falling ball was bent, and a force was applied to a portion other than the flat part (a location away from the flat portion) and caused damage to the foamed blow-molded article, the case was not counted as the falling ball test, and the falling ball test was performed again. Based on the results of the falling ball test, the cold-impact resistance of the foamed blow-molded article was evaluated based on the following criteria.
A (very good): the foamed blow-molded article is not cracked.
B (good): cracks are observed in the foamed blow-molded article, but no scattering of fragments is observed.
C (poor): the foamed blow-molded article is cracked, and scattering of broken pieces of the foamed blow-molded article is observed.

In each of Examples and Comparative Examples, 10 samples were prepared as a foamed blow-molded article for performing the −10° C. falling ball test, the cold-impact resistance of the foamed blow-molded article was evaluated by using each sample, and the number of samples in which the evaluation result was A or B (the number of good samples) was counted. Results are indicated in Tables 2, 3, and 4.

### (Evaluation of Surface Smoothness)

The surface smoothness of the foamed blow-molded article indicates the smoothness of the inner side surface of the hollow portion of the foamed blow-molded article. The surface smoothness of the foamed blow-molded article was performed by cutting out the flat portion of the hollow portion in the hollow foamed blow-molded article and visually observing the inner surface of the foamed blow-molded article in the flat portion. The surface smoothness of the foamed blow-molded article was evaluated based on the following criteria.

A (good): when visually observing the inner surface of the hollow portion of the foamed blow-molded article, the case where the number of locations formed in unevenness, in which a height difference between adjacent unevenness (a difference between a bottom position of a concave portion and a tip position of a convex portion) was 1 mm or more, is one or fewer per 100 cm² area of the inner surface (including the case in which the unevenness was not recognized in the inner surface of the hollow portion).

B (poor): when visually observing the inner surface of the hollow portion of the foamed blow-molded article, the case where the number of locations formed in unevenness, in which a height difference between adjacent unevenness (a difference between a bottom position of a concave portion and a tip position of a convex portion) was 1 mm or more, is two or more per 100 cm² area of the inner surface of the hollow portion.

In Tables 2, 3, and 4, in the field of the surface smoothness, the number of recognized locations of the location formed in unevenness is described in addition to the evaluation result. For example, in the foamed blow-molded articles obtained in Examples 1 to 5, the number of locations formed in unevenness was 0 (that is, no unevenness was observed in the inner surface).

In Examples 1 to 5, it was confirmed that foamed blow-molded articles excellent in cold-impact resistance and surface smoothness were obtained as indicated in Table 2. It was also confirmed that the foamed blow-molded articles had a flexural modulus of a value corresponding to the rigidity generally required for applications such as a duct.

In Comparative Examples 1 and 2, the blending ratio of the polyolefin-based resin and the elastomer in the mixed resin was changed as compared with that in Example 2, and as indicated in Table 3, both the impact resistance and the surface smoothness required for the foamed blow-molded article were not achieved.

In Comparative Examples 3 to 6, the type of elastomer was changed as compared with that in Example 1 and the like, and as indicated in Tables 3 and 4, both the impact resistance and the surface smoothness required for the foamed blow-molded article were not achieved.

In Comparative Examples 7 and 8, the blending amount of the linear block polypropylene (a) was changed as compared with that in Example 1 and the like, and as indicated in Table 4, both the impact resistance and the surface smoothness required for the foamed blow-molded article were not achieved. In Comparative Examples 7 and 8, as indicated in Table 4, values of flexural modulus were low as compared with those in Examples 1 to 5, and the rigidity of the foamed blow-molded article was insufficient.

In Comparative Example 9, the linear block polypropylene used in Example 1 and the like was changed to linear homopolypropylene, and as indicated in Table 4, both the impact resistance and the surface smoothness required for the foamed blow-molded article were not achieved.

TABLE 2

| | | | | Ex. 1 | Ex. 2 | Ex. 3 | Ex. 4 | Ex. 5 |
|---|---|---|---|---|---|---|---|---|
| Mixed | Polyolefin- | Branched homopolypropylene (a1) | Type | WB140 | WB140 | WB140 | WB140 | WB140 |
| resin | based resin | | Blending ratio | 81 | 88 | 88 | 88 | 80 |
| | | Linear block polypropylene (a2) | Type | BC03GS | BC03GS | BC6DRF | CM688A | BC03GS |
| | | | Blending ratio | 19 | 12 | 12 | 12 | 20 |
| | | Linear homopolypropylene | Type | — | — | — | — | — |
| | | | Blending ratio | — | — | — | — | — |

| | | Total blending ratio of polyolefin-based resin | | 100 | 100 | 100 | 100 | 100 |
|---|---|---|---|---|---|---|---|---|
| | Elastomer | Types of olefin-based thermoplastic elastomer (B) | | 6200P | 6200P | 6200P | 6200P | 6200P |
| | | Blending amount (parts by mass) of (B) with respect | | 25 | 25 | 25 | 25 | 33 |
| | | to polyolefin-based resin | | | | | | |
| | | Types of elastomers other than above (B) | | — | — | — | — | — |
| | | Blending amount (parts by mass) of elastomers other | | — | — | — | — | — |
| | | than (B) with respect to polyolefin-based resin | | | | | | |
| Foaming agent (mol/kg) | | | | 0.26 | 0.23 | 0.23 | 0.24 | 0.27 |
| Foamed | Physical | Apparent density (kg/m³) | | 225 | 209 | 265 | 265 | 243 |
| blow- | properties | Thickness (mm) | | 2.1 | 2.1 | 2.1 | 2 | 2.1 |
| molded | | Closed cell ratio (%) | | 73 | 73 | 73 | 70 | 71 |
| article | | Flexural modulus (MPa) | | 167 | 159 | 198 | 190 | 163 |
| | Cold-impact | −10° C. falling ball test | Number of | 10 | 10 | 10 | 10 | 10 |
| | resistance | (1.5 m, 1 kg) | favorable samples | | | | | |

| | | | | | | |
|---|---|---|---|---|---|---|
| Surface smoothness | Evaluation | A | A | A | A | A |

| | | | | | |
|---|---|---|---|---|---|
| Number of uneven portions | 0 | 0 | 0 | 0 | 0 |

TABLE 3

| | | | | Comp. | Comp. | Comp. | Comp. |
|---|---|---|---|---|---|---|---|
| | | | | Ex. 1 | Ex. 2 | Ex. 3 | Ex. 4 |
| Mixed | Polyolefin- | Branched homopolypropylene (a1) | Type | WB140 | WB140 | WB140 | WB140 |
| resin | based resin | | Blending ratio | 82 | 79 | 81 | 81 |
| | | Linear block polypropylene (a2) | Type | BC03GS | BC03GS | BC03GS | BC03GS |
| | | | Blending ratio | 18 | 21 | 19 | 19 |
| | | Linear polypropylene | Type | — | — | — | — |
| | | | Blending ratio | — | — | — | — |

| | | Total blending ratio of polyolefin-based resin | | 100 | 100 | 100 | 100 |
|---|---|---|---|---|---|---|---|
| | Elastomer | Types of olefin-based thermoplastic elastomer (B) | | 6200P | 6200P | — | — |
| | | Blending amount (parts by mass) of (B) with respect | | 17 | 43 | — | — |
| | | to polyolefin-based resin | | | | | |
| | | Types of elastomers other than above (B) | | — | — | H1041 | Q100F |
| | | Blending amount (parts by mass) of elastomers other | | — | — | 25 | 25 |
| | | than (B) with respect to polyolefin-based resin | | | | | |
| Foaming agent (mol/kg) | | | | 0.24 | 0.28 | 0.26 | 0.24 |
| Foamed | Physical | Apparent density (kg/m³) | | 214 | 300 | 391 | 214 |
| blow- | properties | Thickness (mm) | | 2.1 | 2.1 | 1.9 | 2 |
| molded | | Closed cell ratio (%) | | 75 | 60 | 62 | 72 |
| article | | Flexural modulus (MPa) | | 194 | 157 | 267 | 180 |
| | Cold-impact | −10° C. falling ball test | Number of | 0 | 10 | 10 | 0 |
| | resistance | (1.5 m, 1 kg) | favorable samples | | | | |

| | | | | | |
|---|---|---|---|---|---|
| Surface smoothness | Evaluation | A | B | B | A |

| | | | | |
|---|---|---|---|---|
| Number of uneven portions | 0 | 12 | 10 | 0 |

TABLE 4

| | | | | Comp. | Comp. | Comp. | Comp. | Comp. |
|---|---|---|---|---|---|---|---|---|
| | | | | Ex. 5 | Ex. 6 | Ex. 7 | Ex. 8 | Ex. 9 |
| Mixed | Polyolefin- | Branched homopolypropylene (a1) | Type | WB140 | WB140 | WB140 | WB140 | WB140 |
| resin | based resin | | Blending ratio | 81 | 81 | 100 | 94 | 81 |
| | | Linear block polypropylene (a2) | Type | BC03GS | BC03GS | — | BC03GS | — |
| | | | Blending ratio | 19 | 19 | — | 6 | — |
| | | Linear polypropylene | Type | — | — | — | — | J106G |
| | | | Blending ratio | — | — | — | — | 19 |

| | | Total blending ratio of polyolefin-based resin | | 100 | 100 | 100 | 100 | 100 |
|---|---|---|---|---|---|---|---|---|
| | Elastomer | Types of olefin-based thermoplastic elastomer (B) | | — | — | 6200P | 6200P | 6200P |
| | | Blending amount (parts by mass) of (B) with respect | | — | — | 25 | 25 | 25 |
| | | to polyolefin-based resin | | | | | | |
| | | Types of elastomers other than above (B) | | DF605 | 6202 | — | — | — |
| | | Blending amount (parts by mass) of elastomers other | | 25 | 25 | — | — | — |
| | | than (B) with respect to polyolefin-based resin | | | | | | |
| Foaming agent (mol/kg) | | | | 0.24 | 0.26 | 0.18 | 0.23 | 0.26 |
| Foamed | Physical | Apparent density (kg/m³) | | 220 | 225 | 231 | 214 | 225 |
| blow- | properties | Thickness (mm) | | 2.1 | 1.9 | 2.2 | 2.1 | 2 |
| molded | | Closed cell ratio (%) | | 68 | 75 | 85 | 76 | 82 |
| size | | Flexural modulus (MPa) | | 182 | 135 | 144 | 144 | 161 |
| | Cold-impact | −10° C. falling ball test | Number of | 2 | 0 | 0 | 2 | 0 |
| | resistance | (1.5 m, 1 kg) | favorable samples | | | | | |

| | | | | | | |
|---|---|---|---|---|---|---|
| Surface soothnesss | Evaluation | B | A | A | A | A |

| | | | | | |
|---|---|---|---|---|---|
| Number of uneven portions | 4 | 0 | 0 | 0 | 0 |

The above-described production method and examples of the present invention are examples, and the present invention is not limited thereto. In the technique disclosed in the present invention, for example, various attributes of the branched homopolypropylene (a1) may be combined. In the technique disclosed in the present invention, for example, the branched homopolypropylene (a1) may have a specific melt tension and a specific melting point. These are also applied to not only the branched homopolypropylene (a1) but also the linear block polypropylene (a2), the olefin-based thermoplastic elastomer (B), and the recovered raw material. However, the combinations described above are merely examples, and the present invention is not limited thereto.

1. A method for producing a foamed blow-molded article, the method comprising:
a step of blow-molding a foamed parison obtained by foaming a mixed resin comprising a polyolefin-based resin (A) and an olefin-based thermoplastic elastomer (B), wherein
the polyolefin-based resin (A) comprises a branched homopolypropylene (a1) and a linear block polypropylene (a2), and a mass ratio [(a1):(a2)] of the branched homopolypropylene (a1) to the linear block polypropylene (a2) is 50:50 to 93:7,
the olefin-based thermoplastic elastomer (B) is a hydrogenated product of a triblock copolymer comprising a crystalline olefin polymer block and a polymer block of a conjugated diene compound, and
in the mixed resin, a blending amount of the olefin-based thermoplastic elastomer (B) with respect to 100 parts by mass of the polyolefin-based resin (A) is 20 parts by mass or more and 40 parts by mass or less.

2. The method for producing a foamed blow-molded article according to claim 1, wherein
the olefin-based thermoplastic elastomer (B) has a melting point of 80° C. or higher and 100° C. or lower.

3. The method for producing a foamed blow-molded article according to claim 1, wherein
the linear block polypropylene (a2) has a flexural modulus of 1000 MPa or higher and 1500 MPa or lower.

4. The method for producing a foamed blow-molded article according to claim 1, wherein
the olefin-based thermoplastic elastomer (B) has a melt flow rate (at 230° C. and a load of 2.16 kg) of 1 g/10 min or more and 10 g/10 min or less.

5. A foamed blow-molded article of a mixed resin comprising a polyolefin-based resin (A) and an olefin-based thermoplastic elastomer (B), wherein
the polyolefin-based resin (A) comprises a branched homopolypropylene (a1) and a linear block polypropylene (a2), and a mass ratio [(a1):(a2)] of the branched homopolypropylene (a1) to the linear block polypropylene (a2) is 50:50 to 93:7,
the olefin-based thermoplastic elastomer (B) is a hydrogenated product of a triblock copolymer comprising a crystalline olefin polymer block and a polymer block of a conjugated diene compound, and
in the mixed resin, a blending amount of the olefin-based thermoplastic elastomer (B) with respect to 100 parts by mass of the polyolefin-based resin (A) is 20 parts by mass or more and 40 parts by mass or less.
